(19) United States
(12) Patent Application Publication
(10) Pub. No.: US 2015/0105953 A1
(43) Pub. Date: Apr. 16, 2015

(54) VIBRATION CONTROL APPARATUS OF VEHICLE WITH MOTOR

(71) Applicant: HYUNDAI MOTOR COMPANY, Seoul (KR)

(72) Inventor: Sang Joon KIM, Seoul (KR)

(73) Assignee: HYUNDAI MOTOR COMPANY, Seoul (KR)

(21) Appl. No.: 14/145,352

(22) Filed: Dec. 31, 2013

(30) Foreign Application Priority Data
Oct. 11, 2013 (KR) 10-2013-0121143

(51) Int. Cl. B60L 15/20

(52) U.S. Cl. CPC B60L 15/2009
USPC 701/22

(57) ABSTRACT

A vehicle vibration control apparatus includes a motor for supplying driving torque; left and right drive wheels at the s ends of a drive shaft rotated by driving torque produced by a motor; ABS for controlling braking force applied with the drive wheels; and a control unit for controlling the rotational speed of the motor to follow rotational speed of the drive wheels when the ABS is operated. Thereby, vibration generated between the motor 10 and the drive wheel 22 and 24 can be minimized.

### CROSS-REFERENCE TO RELATED APPLICATION

This application claims priority to and the benefit of Korean Patent Application No. 10-2013-0121143 filed in the Korean Intellectual Property Office on Oct. 11, 2013, the entire contents of which are incorporated herein by reference.

### BACKGROUND

(a) Technical Field

The present invention relates generally to a vibration control apparatus of a vehicle with a motor. More particularly, the present invention rapidly reduces torsional vibration generated at a drive train of a hybrid or electric vehicle when ABS is operated.

(b) Description of the Related Art

Generally, in a hydraulic pressure brake system, hydraulic brake pressure generated by operation of a brake pedal is supplied to each wheel, thereby a vehicle is slowed or stopped. At this time, slip between the tire and a road occurs when a braking force larger than a static friction force is supplied to a tire.

As is known, a dynamic friction coefficient is less than a static friction coefficient. In order to exhibit an optimal brake effect, slipping between the tire and the road must be prevented. In addition, it is needed to prevent the wheels from locking up. Thus, an antilock brake system (ABS) is used for preventing slip and locking up by controlling hydraulic brake pressure supplied to each wheel. The ABS includes a plurality of solenoid valves controlling hydraulic brake pressure transmitted to each hydraulic pressure brake, accumulator, electric control unit (ECU) controlling a hydraulic pressure control apparatus and electric/electronic devices such as a hydraulic pressure pump.

The ABS detects a slip generated by an operation of brake at a slippery road or by quick braking, and reduces or sustains or increases the hydraulic brake pressure. Thereby the vehicle can obtain optimal cornering force and be stopped at shortest distance while maintaining steering stability.

Meanwhile, an electric vehicle or a hybrid vehicle generally uses ABS, like a general engine vehicle. However, an electric or vehicle does not provide friction and damping components such as an engine, a transmission, a clutch and a torque converter, unlike a general engine vehicle.

Therefore, vibration excessively occurs in the drive train including the motor by braking force when the vehicle is slowed or stopped by using ABS of the electric vehicle or the hybrid vehicle.

Particularly, the rotational inertia of the motor in the drive train of the electric vehicle or the hybrid vehicle cannot compare with the rotational inertia of a drive shaft and a drive wheel, and the drive train is not a rigid body. Thus a difference in rotational speed between the motor and the drive wheel when locking and releasing the drive wheel repeatedly occurs by operation of the ABS.

Therefore, twisting arises from the rotational speed difference between the motor and the drive wheel, and vibration is thereby produced. Particularly, there is a problem in that the vibration generated at the drive train is high because operation frequency of the ABS is high.

Conventionally, in order to suppress the vibration generated between the motor and the drive wheel when the ABS is operated, the operation frequency is set to be relatively low. However, braking distance is increased according to this conventional method.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to minimize torsional vibration by rotation speed between a motor and drive wheels when the ABS of an electric vehicle or a hybrid vehicle is operated.

A vibration control apparatus of vehicle with motor according to an exemplary embodiment of the present invention includes: a motor for supplying driving torque; a left drive wheel and a right drive wheel installed at the ends of a drive shaft rotated by driving torque produced by the motor; ABS for controlling braking force applied with the drive wheels; and a control unit for controlling rotation speed of the motor to follow rotation speed of the drive wheels when the ABS is operated.

The control unit compares the motor speed with a target speed determined as an average value of the left and right drive wheel rotational speeds and controls motor speed to follow the target speed.

The control unit calculates an inertial torque of the motor by using rotational acceleration of the motor and produces a torque command of the motor in the direction opposite the inertial torque.

The control unit does not control that the motor speed to follow the drive wheel speed when the rotational acceleration of the motor is less than a predetermined value.

### BRIEF DESCRIPTION OF THE DRAWINGS

The drawings are provided for reference in describing exemplary embodiments of the present invention and the spirit of the present invention should not be construed only by the accompanying drawings.

FIG. 1 schematically shows a drive train of general electric vehicle or hybrid vehicle.

FIG. 2 shows a symbolic view of a drive train of a general electric vehicle or hybrid vehicle.

FIG. 3 shows variation of speed and acceleration of a general electric vehicle or hybrid vehicle when ABS is operated.

FIG. 4 is a block diagram of a vibration control process of an electric vehicle or a hybrid vehicle according to an exemplary embodiment of the present invention.

FIG. 5 is a flow chart of a vibration control process of an electric vehicle or a hybrid vehicle according to an exemplary embodiment of the present invention.

FIG. 6 is a block diagram of a vibration control process of an electric vehicle or a hybrid vehicle according to another exemplary embodiment of the present invention.

FIG. 7 is a flow chart of a vibration control process of an electric vehicle or a hybrid vehicle according to another exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clearly describe the present invention, portions that are not connected with the description will be omitted. Like reference numerals designate like elements throughout the specification.

In addition, the size and thickness of each configuration shown in the drawings are arbitrarily shown for better understanding and ease of description, but the present invention is not limited thereto. In the drawings, the thickness of layers, films, panels, regions, etc., are exaggerated for clarity.

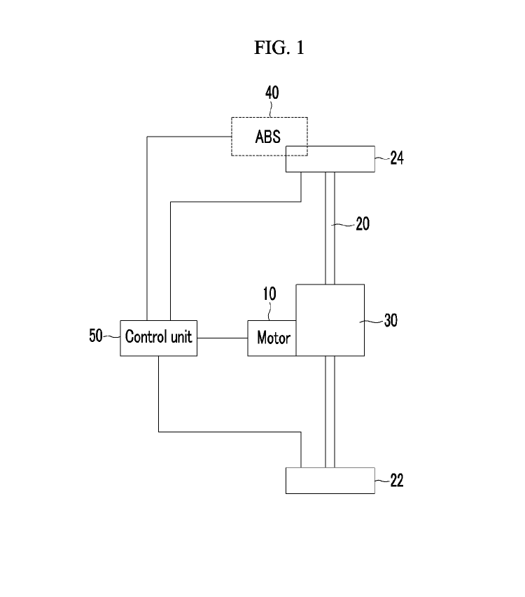

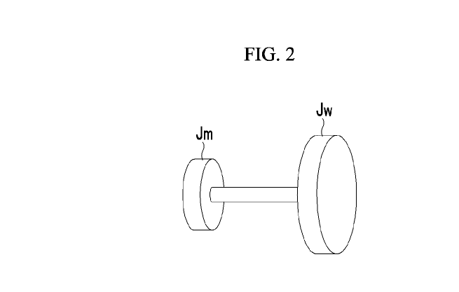

FIG. 1 schematically shows a drive train of a general electric vehicle or hybrid vehicle. FIG. 2 shows a symbolic view of a drive train of a general electric vehicle or hybrid vehicle.

As shown in FIG. 1 and FIG. 2, an electric vehicle or a hybrid vehicle includes a motor 10 for supplying a driving torque, a left drive wheel 22 and a right drive wheel 24 installed at both side of a drive shaft 20 rotated by driving torque produced by the motor 10, an ABS 40 for controlling braking force applied to the drive wheels, and a control unit 50 for controlling rotational speed of the motor 10 to follow rotational speed of the drive wheels when the ABS 40 is operated.

A speed detecting sensor (not shown) for detecting rotational speed of the motor 10 and the drive wheels 22 and 24 is provided in the motor 10 and the drive wheels 22 and 24. The rotational inertia (Jm) of the motor 10 can be calculated by the core of motor 10 and a rotational inertia of a speed reduction unit 30 installed between the motor 10 and a drive shaft 20. The rotational inertia (Jw) of a vehicle body can be calculated based on rotational inertia of the drive shaft 20 and rotational inertia of the drive wheels 22 and 24.

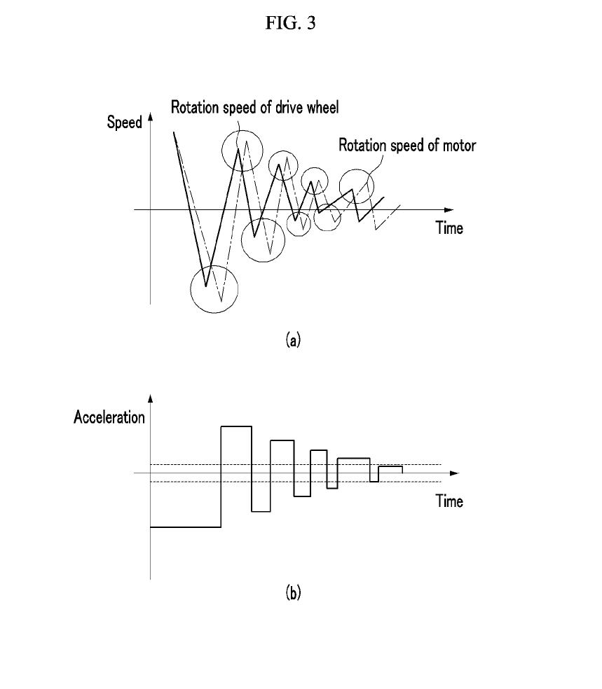

FIG. 3 shows a variation of speed and acceleration of a general electric vehicle or hybrid vehicle when ABS is operated.

As shown in FIG. 3, the rotational speed of the motor 10 is different from the rotational speeds of the drive wheels 22 and 24 according to time.

If the motor 10 and the drive wheels 22 and 24 are formed as a perfect rigid body, difference between the rotational speed between the drive shaft 20 and the motor 10 does not occur. Therefore, any vibration by twisting between the motor 10 and the drive shaft 20 is not produced. However, since the rotational speed of the motor 10 is different from the rotational speed of the drive shaft 20 in practice, there is a need to control the rotational speed of the motor 10 so as not to incur any difference in rotational speeds of the drive shaft 20 and the motor 10.

As such, if the difference between the rotational speeds of the drive shaft 20 and the motor 10 is zero, then the motor 10 and the drive shaft 20 and drive wheel 22 and 24 are to be a rigid body virtually. Thereby, torsional vibration generated among the motor 10, the drive shaft 20 and the drive wheels 22 and 24 would be minimized.

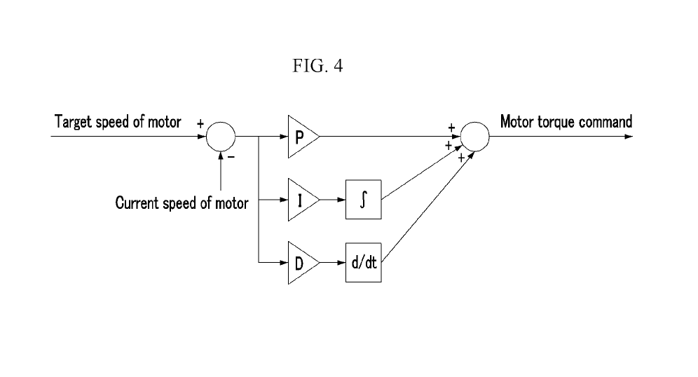

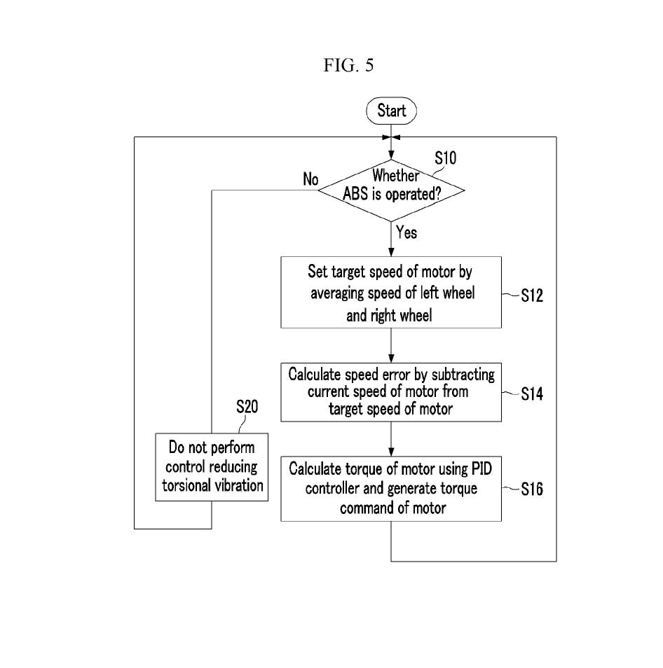

FIG. 4 is a block diagram of a vibration control process of an electric vehicle or a hybrid vehicle according to an exemplary embodiment of the present invention. FIG. 5 is flow chart of a vibration control process of an electric vehicle or a hybrid vehicle according to an exemplary embodiment of the present invention.

As shown in FIG. 4, the control unit 50 compares current speed of the motor 10 with target speed of the motor 10, and controls the difference between current speed of the motor 10 and target speed of the motor 10 to be minimized so that the rotational speed of the motor 10 follows the rotational speeds of the drive wheels 22 and 24.

At this time, the target speed of the motor 10 is set as average value of the rotation speed of the left and right drive wheels 22 and 24.

The control unit 50 generates a motor torque command by a proportional integral derivative control (PID) and controls that the rotational speed of the motor 10 follows the rotational speed of the drive wheels 22 and 24, so that the rotational speed of the motor 10 follows the rotation speeds of the drive wheel 22 and 24.

The above control process will be described in detail referring to FIG. 5.

First, the control unit 50 determines whether the ABS 40 is operated at step S10. If the ABS 40 is not operated, then control for reducing torsional vibration produced between the motor 10 and the drive wheel 22 and 24 is not performed at step of S20.

If the ABS 40 is operated, the target speed of the motor 10 is set as the average speed of the left wheel and the right wheels at step of S12.

The control unit 50 calculates speed error between the rotational speed of the motor 10 and the rotational speed of the drive wheel 22 and 24 at step S14. The speed error can be calculated by subtracting the current speed of the motor 10 from the target speed of the motor 10.

The control unit 50 calculates torque of the motor 10 by using the PID controller and generates torque command of the motor 10 at step S16.

Hereinafter, a vibration control method of a vehicle with a motor such as a hybrid vehicle or an electric vehicle according to another exemplary embodiment of the present invention will be described.

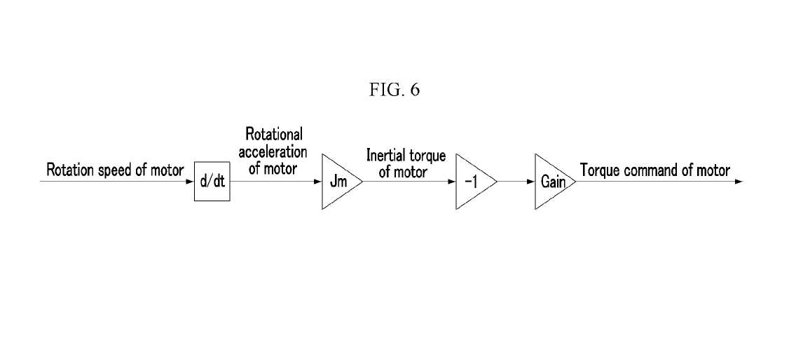

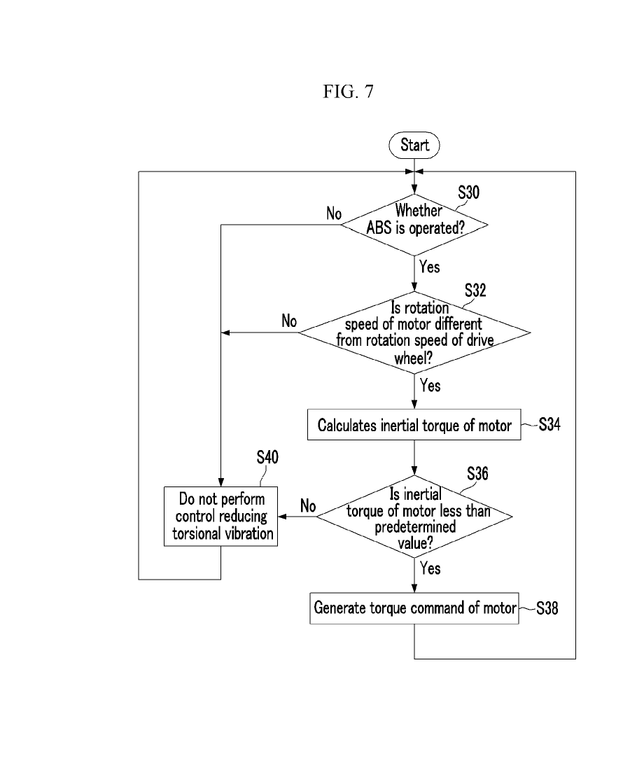

FIG. 6 is a block diagram of a vibration control process of an electric vehicle or a hybrid vehicle according to another exemplary embodiment of the present invention. FIG. 7 is a flow chart of a vibration control process of an electric vehicle or a hybrid vehicle according to another exemplary embodiment of the present invention.

As shown in FIG. 6, control unit 50 calculates a motor torque of rotational inertia by using rotational acceleration of the motor 10 when a difference between the rotational speed of the motor 10 and that of the drive wheels 22 and 24 occurs. That is, the controller 50 calculates rotational acceleration of the motor 10 by differentiating the rotational speed the motor 10, and calculates the inertial torque of the motor 10 by multiplying the rotational acceleration by the moment of inertia of the motor 10.

Control unit 50 generates a torque command of the motor 10 by multiplying the inertial torque of the motor 10 by minus gain. That is, the control unit 50 generates the torque command of the motor 10 in the opposite direction to that of the current inertial torque and controls the rotational inertia of the motor 10 to be zero. Therefore, vibration generated between the motor 10 and the drive wheel 22 and 24 can be minimized.

Meanwhile, the control unit 50 does not perform reducing of torsional vibration generated between the motor 10 and the drive wheels 22 and 24 when the inertial torque of the motor 10 is less than a predetermined value.

That the rotational acceleration is small means that a rotational speed change rate of the motor 10 is small. In this case, if the control unit 50 controls the rotational speed of the motor 10 to follow the rotational speed of the drive wheels 22 and 24, then the rotational speed of the motor 10 cannot follow the rotational speed of the drive wheels 22 and 24 substantially and the motor 10 is oscillated unstably.

The above control process will be described in detail referring to FIG. 7.

First, the control unit 50 determines whether the ABS 40 is operated at step of S30. If the ABS 40 is not operated, then control for reducing torsional vibration generated between the motor 10 and the drive wheel 22 and 24 is not performed at step S40.

Control unit 50 detects the rotational speed of the motor 10 and the drive wheels 22 and 24 at step S32. If the rotational speed of the motor 10 is not different from the rotation speed of the drive wheels 22 and 24, the control process for reducing torsional vibration generated between the motor 10 and the drive wheel 22 and 24 is not performed at step S40.

The control unit 50 determines any difference between the rotational speed of the motor 10 and the rotational speed of the drive wheels 22 and 24 at step S32. If the rotational speed of the motor 10 is different from the rotational speed of the drive wheels 22 and 24, then the control unit 50 calculates a rotational acceleration of the motor 10 by differentiating the rotational speed of the motor 10. Control unit 50 calculates an inertial torque of the motor 10 by multiplying the rotational acceleration by the moment of inertia of the motor 10 at step S34.

If the inertial torque of the motor 10 is less than a predetermined value, then the control unit 50 does not perform a process for reducing torsional vibration generated between the motor 10 and the drive wheels 22 and 24 at step S40.

If inertial torque of the motor 10 is larger than the predetermined value at step S36, the control unit 50 generates a torque command to the motor 10 by multiplying the inertial torque of the motor 10 by the minus gain at step S38.

According to the vibration control apparatus with motor of an exemplary embodiment of the present invention, any difference in rotational speed between the motor 10 and the drive wheels 22 and 24 can be minimized, and the motor 10 and the drive wheel 22 and 24 can be operated like a rigid body.

As such, since the motor 10 and the drive wheel 22 and 24 are operated like a rigid body, vibration by twisting between the motor 10 and the drive wheels 22 and 24 can be minimized.

According to the vibration control apparatus with motor of another exemplary embodiment of the present invention, the control unit detects a rotational speed of the motor and the drive wheels when the ABS is operated, and controls that the rotational speed of the motor 10 to follow the rotational speed of the drive wheels 22 and 24. Thereby, vibration generated between the motor 10 and the drive wheels 22 and 24 can be minimized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A vibration control apparatus of a vehicle having a motor comprising:
a motor for supplying driving torque;
a left drive wheel and a right drive wheel installed at opposite ends of a drive shaft rotated by driving torque produced by the motor;
ABS for controlling braking force applied with the drive wheels; and
a control unit configured for controlling rotational speed of the motor to follow rotational speed of drive wheels when the ABS is operated and not to control motor speed to follow the drive wheel speed when a rotational acceleration of the motor is less than a predetermined value;
the control unit being further configured to calculate an inertial torque of the motor by using the rotational acceleration of the motor and to generate a torque command of the motor in a direction opposite that of the inertial torque.

2. The vibration control apparatus of vehicle with motor of claim 1,
wherein the control unit compares the motor speed with a target speed determined as an average value of the left and right drive wheel speeds, and controls the motor speed to follow the target speed.

3-4. (canceled)

5. A vibration control apparatus of a vehicle having a motor comprising:
a motor for supplying driving torque;
a left drive wheel and a right drive wheel installed at opposite ends of a drive shaft rotated by driving torque produced by the motor;
ABS for controlling braking force applied with the drive wheels; and
a control unit configured for determining a rotational acceleration of the motor, and for controlling rotational speed of the motor to follow rotational speed of drive wheels when the ABS is operated and not to control motor speed to follow the drive wheel speed when the determined rotational acceleration of the motor is less than a predetermined value.

6. The vibration control apparatus of vehicle with motor of claim 5, wherein the control unit is further configured to calculate an inertial torque of the motor by using the determined rotational acceleration of the motor and to generate a torque command of the motor in a direction opposite that of the inertial torque.
